(19) United States
(12) Patent Application Publication
(10) Pub. No.: US 2009/0108817 A1
(43) Pub. Date: Apr. 30, 2009

(54) Method for actuation by boosting power source voltage

(75) Inventor: Michael Chen, Taipei Hsien (TW)

Correspondence Address: Joe McKinney Muncy, PO Box 1364, Fairfax, VA, 22038-1364, US

(73) Assignee: TOPOWER COMPUTER INDUSTRIAL CO., LTD.

(21) Appl. No.: 11/979,058

(22) Filed: Oct. 30, 2007

(51) Int. Cl. G05F 1/10

(52) U.S. Cl. 323/234

(57) ABSTRACT

A method for actuation by boosting power source voltage includes: determining an overclocking range of an electronic device, setting a duty frequency of the electronic device, detecting actuation conditions of the electronic device, and switching actuation power value. First, get the upper limit of the duty frequency of the electronic device to determine the overclocking range of the electronic device; then determine the duty frequency of the electronic device after actuated, detect the electronic device to get an actuation power from a power source and determine whether the electronic device is started properly. If the electronic device is not started properly, alter the voltage of the actuation power, and determine again the actuation condition of the electronic device. By means of the aforesaid procedure the actuation power voltage value input to the electronic device can be regulated to actuate the electronic device.

### FIELD OF THE INVENTION

The present invention relates to a method for actuation by boosting power source voltage to regulate output of a power supply.

### BACKGROUND OF THE INVENTION

Application scopes of computers have expanded widely nowadays. Multi-processing operation systems and various types of application programs are available to provide different utilizations and meet a wide range of requirements. The processing speed of computer hardware and data register and transmission speed also have to increase to meet these challenges. In the past low end sound card and display card are integrated with the motherboard to save space and cost to meet the requirements of general users. But integrating the low end sound card and display card cannot meet huge processing requirement of complex software (usually for more specialized applications such as games or video processing). Hence many independent computer equipments coupling with the motherboard have been developed and introduced to meet the processing requirements of most software. However, those independent computer equipments (such as sound card and display card) require a greater amount of power than the low end computer equipments. Moreover, aside from the sound card and display card, memory (RAM) card also requires a higher duty voltage as the duty frequency increases. Some users even try to manually boost the duty frequency of the memory card over the rated frequency set by the producers. As a result, the required duty voltage is even higher. If the voltage provided by a power supply cannot meet the duty voltage of various computer equipments at the start instant, the computer cannot be started, and also cannot enter BIOS (basic I/O system) to regulate the voltage. And the computer cannot function as desired. There are proposals in prior art trying to solve this problem. For instance, R.O.C. patent publication No. M266640 entitled Regulation structure for output voltage” provides a power source with a plurality of voltage dividing resistors and an output end to deliver power. The voltage dividing resistors further are connected to another connector and another resistor, and the another connector is connected to two resistors in a straddle manner. Hence the two resistors are coupled in parallel to alter the equivalent resistance. And different voltage dividing effect is formed to regulate the output voltage at the output end. In the event that output voltage is not adequate to do machine start, the aforesaid structure allows users to change the connectors to alter the output voltage. However, adding the connectors to regulate the voltage increases the cost of power supply. Moreover, when the computer cannot be started, it must be shut down to replace the connectors. To find out and test the right connectors requires a lot of trial and error. It causes a great deal of inconvenience to users and is difficult to use, thus is not practical.

### SUMMARY OF THE INVENTION

In view of the aforesaid problem of inadequate voltage at the start instant of computers, the primary object of the present invention is to provide an improved method to increase the actuation power to enable electronic devices to be actuated smoothly.

The present invention provides a method for actuation by boosting power source voltage. The method includes: determining an overclocking range of an electronic device, setting a duty frequency of the electronic device, detecting actuation conditions of the electronic device, and switching actuation power value. First, get an upper limit of the duty frequency of the electronic device to determine the overclocking range of the electronic device; then determine the duty frequency of the electronic device after started; detect the electronic device to get an actuation power from a power source and determine whether the electronic device starts properly. If the electronic device does not start properly, alter the voltage of the actuation power, and determine again the actuation condition of the electronic device. By means of the aforesaid procedure the actuation power voltage input to the electronic device can be regulated to start the electronic device

A circuit is provided to implement this method. It includes a switch circuit and a switch control device in a power supply which delivers the actuation power. The power supply receives a feedback value at the output end to correct output. The switch circuit has two or more circuits whose ON/OFF is controlled by the switch control device. By pushing or turning the switch control device different feedback values are generated to regulate the actuation power output from the power supply.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a flowchart showing the implementation procedure of the method of the invention.

FIG. 2 is a circuit architecture of an embodiment of the invention.

FIG. 3 is a circuit architecture of another embodiment of the invention.

FIG. 4 is a schematic view of an embodiment of the invention.

### DETAILED DESCRIPTION OF THE PREFERRED EMBODIMENTS

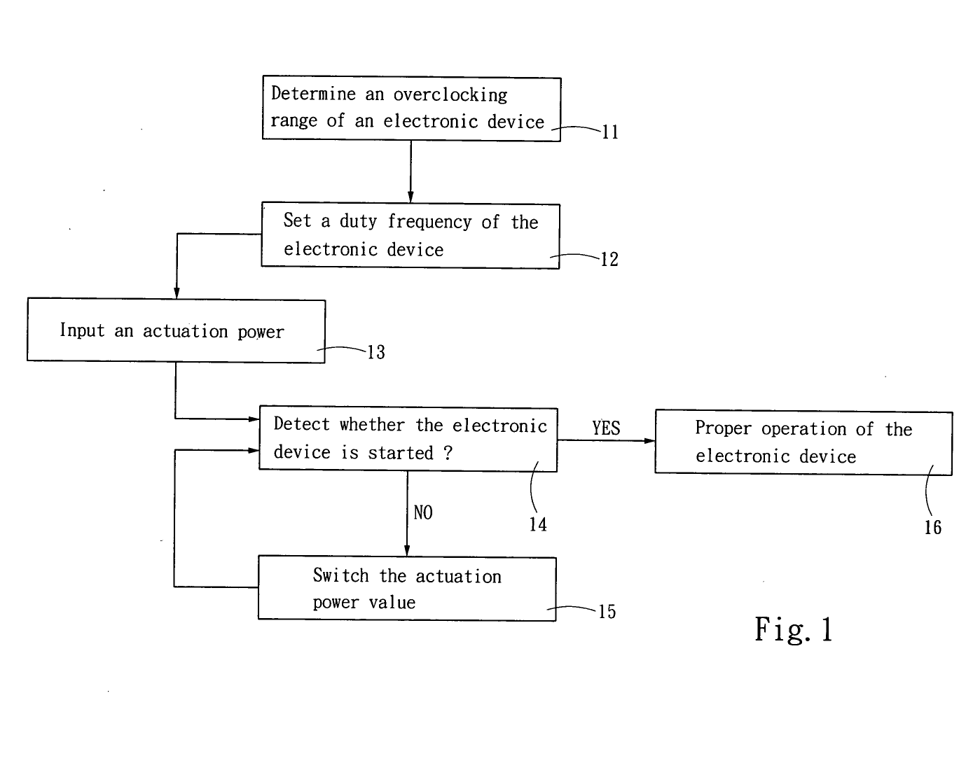

Please refer to FIG. 1 for the procedure of actuation by boosting power source voltage according to the method of the invention. It includes: determining an overclocking range of an electronic device (11), setting a duty frequency of the electronic device (12), inputting an actuation power (13), detecting whether the electronic device is started (14), switching the actuation power value if the electronic device is not being properly started (15), repeating detection of the start condition at step (14), and setting the electronic device in regular operation after it is properly started (16). By means of procedure set forth above one or more electronic devices can be actuated to work in the overclocking condition, or an electronic system consisting of a plurality of electronic devices can be started even if the actuation voltage is not sufficient to start at the same time. The electronic device mentioned above may be a memory or display card, or a central processor in a computer. When the electronic device is set overclocking because the computer regulates the BIOS or a jumper of the motherboard connecting to the electronic device, the electronic device require a higher actuation voltage. The invention gets the upper limit of the duty frequency of the electronic device to determine the overclocking range of the electronic device (11), then determine the duty frequency of the electronic device after start, and determine whether the actuation power is sufficient to start the electronic device properly. If the electronic device cannot be started properly, a higher voltage is provided to actuate again so that the electronic device can operate properly. The actuation power is provided by a power source which can be a power supply or a battery.

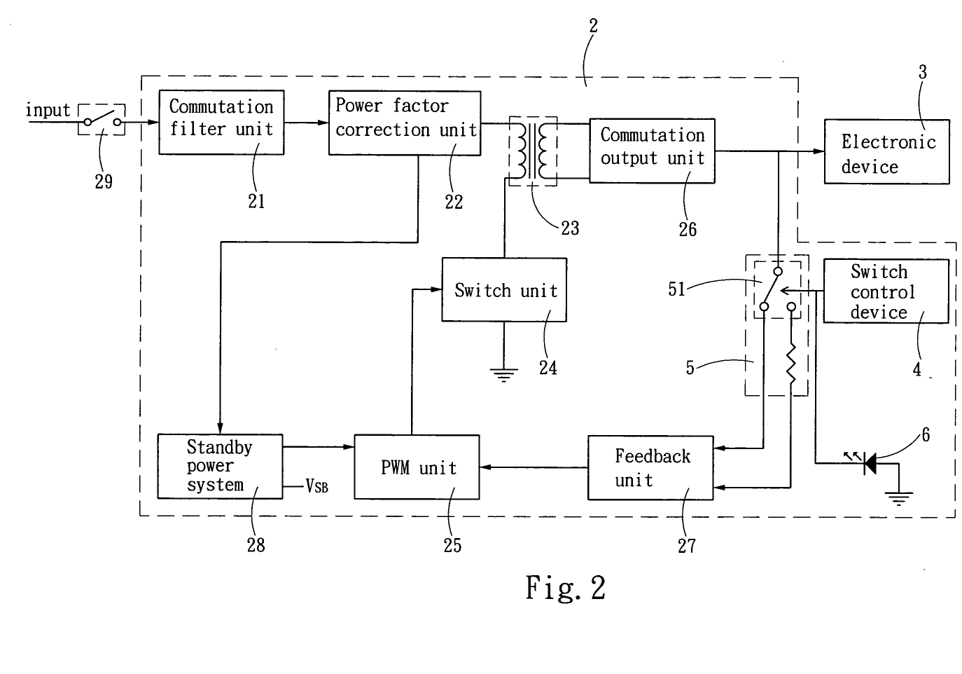

Refer to FIG. 2 for a power supply structure to implement the method of actuation by boosting power source voltage. The power supply 2 receives input power from an external power source and transforms to an actuation power to drive at least one electronic device 3. The power supply 2 includes a switch circuit 5 to switch the actuation power value and a switch control device 4 to trigger operation of the switch circuit 5. Users can push or turn the switch control device 4 to trigger the switch circuit 5 to change the actuation power voltage output from the power supply 2. The power supply 2 includes a start/stop unit 29, a standby power system 28, a commutation filter unit 21 to receive input power, a power factor correction unit 22, a pulse wave modulation (PWM) unit 25, a switch unit 24 with the duty cycle controlled by the PWM unit 25, a transformer 23, a commutation output unit 26 connecting to the secondary side of the transformer 23 and a feedback unit 27. After the start/stop unit 29 is set ON, the input power passes through the power factor correction unit 21, and is sent to the commutation filter unit 21 and the power factor correction unit 22 which sends the power to the standby power system 28 and the transformer 23. The standby power system 28 is triggered and provides a standby power to make the PWM unit 25 to generate a duty cycle signal of the switch unit 24, thereby the transformer 23 transforms the power and sends to the commutation output unit 26, and outputs the actuation power to drive the electronic device 3. The commutation output unit 26 and the electronic device 3 are bridged by the switch circuit 5 to captures a feedback signal. The switch circuit 5 transfers the feedback signal to the feedback unit 27 which serves as a reference of the PWM unit 25 to regulate output. The switch circuit 5 consists of more than one set of impedance circuit and a multi-connection switch device 51. Referring to FIG. 2, the switch circuit 5 has two sets of circuits, and is connected to the switch control device 4. The switch control device 4 may be a pushbutton or rotary knob located on the case of the power supply 2. The switch control device 4 provides two stages switch ON and OFF to control the connection position of the switch device 51. Hence through the switch circuit 5 different impedance values can be switched to alter the intensity of the feedback signal, and further control the PWM unit 25 to boost the voltage output from the transformer 23 to increase the actuation power. The switch circuit 5 further is connected to an LED 6 to display the switching condition of the switch circuit 5 while the switch control device 4 is in operation. By means of the structure set forth above the method of the invention can be implemented. When the electronic device 3 gets the overclocking range and the duty frequency is set, the power supply 2 provides the actuation power to the electronic device 3, and detects whether the electronic device 3 is started properly. The embodiment shown in FIG. 2 is a power supply 2 and electronic device 3 of a computer. The motherboard where the electronic device 3 is installed can output a power supply ON or OFF signal to determine whether the electronic device 3 is set ON properly. When the electronic device 3 does not start normally, users push or turn the switch control device 4 to trigger the switch circuit 5 to switch the actuation power value so that the power supply 2 can output a higher actuation power to enable the electronic device 3 to properly start in an overclocking duty condition.

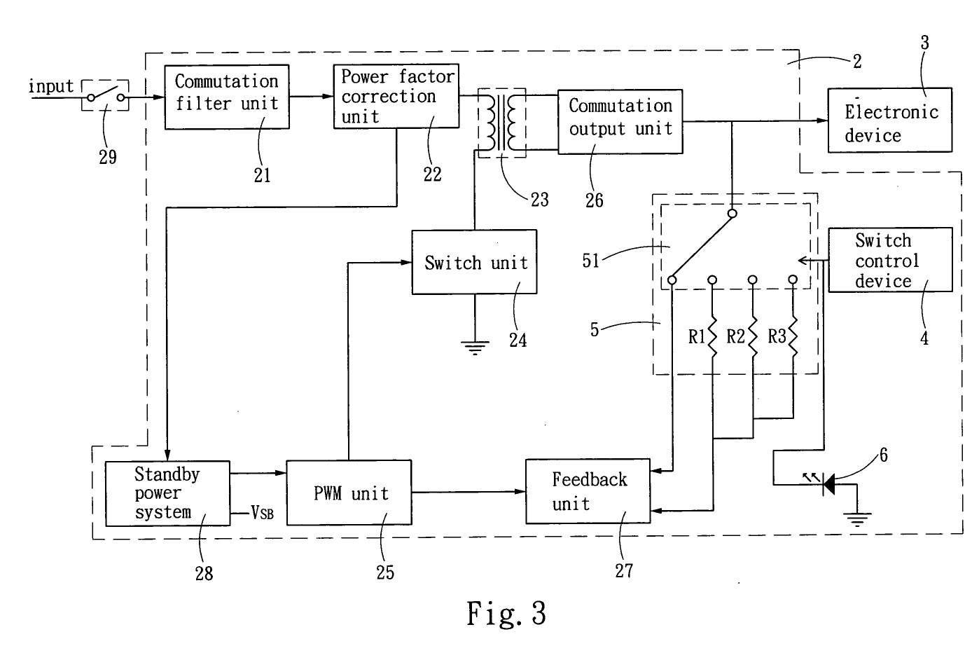

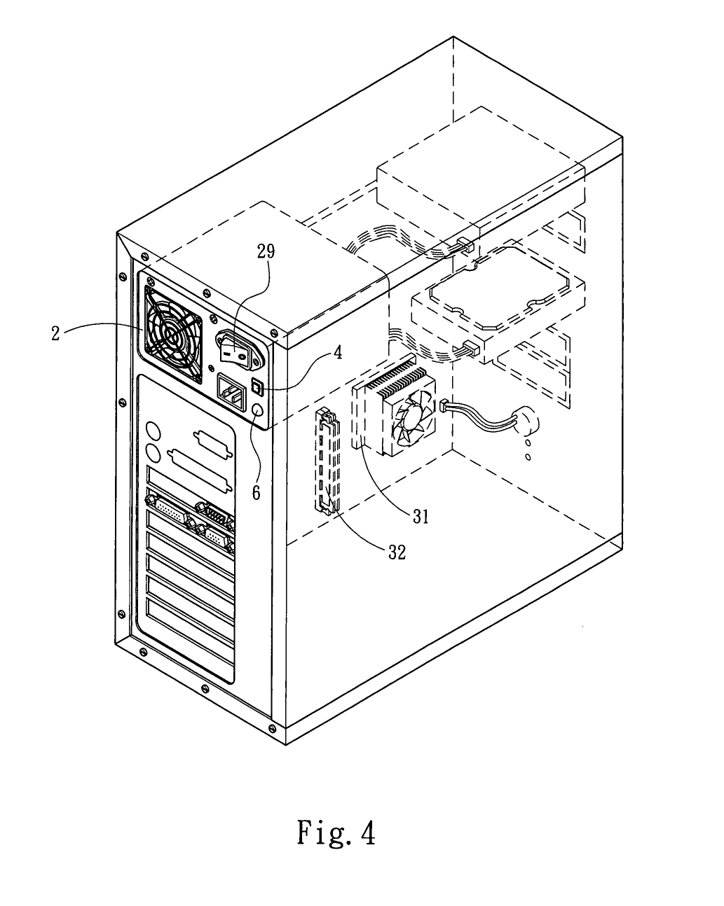

FIG. 3 shows the implementation circuit of another embodiment according to FIG. 2. The power supply 2 and operation principle are the same as previously discussed, thus are omitted. The switch circuit 5 connecting to the commutation output unit 26 has a plurality of circuits of different resistances. In FIG. 3, the switch circuit 5 has resistors R1, R2 and R3 with different resistances. The switch control device 4 has multiple switch conditions to allow users to switch connecting positions of the switch circuit 5 by stages. Hence the actuation power can be adjusted according to actual requirements. The switch circuit 5 also is connected to the LED 6 to display the switching condition of the switch circuit 5 when the switch control device 4 is operating. Referring to FIG. 4, a power supply 2 is installed on a computer chassis to provide required actuation power for the electronic devices 3 such as a central processor 31 and a memory 32 that can function in an overclocking condition. When the central processor 31 and the memory 32 are set at a higher duty frequency, and the rated output actuation power voltage of the power supply 2 is not sufficient to deliver required actuation power to actuate the devices, through the switch control device 4 the actuation power output from the power supply 2 can be boosted to smoothly start the electronic devices 3 such as the central processor 31 and the memory 32. Moreover, the voltage boosting range of the actuation power can be controlled within 3% of the rated output voltage to conform to the computer duty voltage regulation established in the industry.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A method for actuation by boosting power source voltage, comprising:
A. determining an overclocking range of an electronic device by getting an upper limit of a duty frequency of the electronic device;
B. setting the duty frequency of the electronic device after actuated;
C. detecting actuation condition of the electronic device by getting an actuation power from a power source and determining whether the electronic device has been properly started; and
D. switching the actuation power value by altering the voltage of the actuation power and determining again the actuation condition of the electronic device and regulating the actuation power voltage value to actuate the electronic device.

2. The method of claim 1, wherein the electronic device is a memory in a computer.

3. The method of claim 1, wherein the electronic device is a display card in a computer.

4. The method of claim 1, wherein the electronic device is a central processor in a computer.

5. The method of claim 1, wherein the power source is a power supply.

6. The method of claim 5, wherein the power supply includes a switch circuit to switch the actuation power value and a switch control device to trigger operation of the switch circuit.

7. The method of claim 6, wherein the switch circuit includes at least one impedance circuit and a switch device having a plurality of connection positions, the switch device being connected to the switch control device.

8. The method of claim 7, wherein the switch control device is a switch unit to trigger the switch device to alter the connection positions.

9. The method of claim 8, wherein the switch control device is a pushbutton located on a case of the power supply.

10. The method of claim 9, wherein the switch control device is switchable at two stages for ON and OFF.

11. The method of claim 9, wherein the switch control device is switchable at multiple stages.

12. The method of claim 9, wherein the switch control device is connected to a light emitting diode to display switching conditions of the switch circuit.

13. The method of claim 8, wherein the switch control device is a rotary knob located on a case of the power supply.

14. The method of claim 13, wherein the switch control device is switchable at two stages for ON and OFF.

15. The method of claim 13, wherein the switch control device is switchable at multiple stages.

16. The method of claim 13, wherein the switch control device is connected to a light emitting diode to display switching conditions of the switch circuit.
